(19) United States
(12) Patent Application Publication
(10) Pub. No.: US 2007/0163165 A1
(43) Pub. Date: Jul. 19, 2007

(54) Fishing lure and sinker with surface details for holding and distributing fish attractant

(76) Inventors: David J. Castro, Ontario (CA); Raymond A. Castro, Ontario (CA)

Correspondence Address: BUHLER ASSOCIATES;BUHLER, KIRK A., 1101 CALIFORNIA AVE., SUITE 208, CORONA, CA, 92881, US

(21) Appl. No.: 11/333,182

(22) Filed: Jan. 17, 2006

(51) Int. Cl. A01K 85/01; A01K 85/00

(52) U.S. Cl. 43/42.06; 43/42.34

(57) ABSTRACT

Surface treatment for fishing lures and sinkers is disclosed. The surface treatment can exist in a number of configurations, including holes, slots, grooves, or other details. The details have a cross section that allow them to be easily cleaned with a stick, branch, sand or other items that can be found near a lake or stream. The surface treatment allows a person to manually apply fish attractant to the outer surface of the fishing lure, and some of the fish attractant will embed into the surface treatment area providing retention of the fish attractant. In use the fish attractant will be washed from the surface treatment as the lure is moved through the water. The surface treatment can be incorporated into nearly any type of rigid or pliable fishing lure or sinker.

### FIELD OF THE INVENTION

This invention relates generally to fishing lures, and more particularly to fishing lures that are fabricated with surface details that allow a user to apply fish attractant into the surface details. The surface details retain some of the fish attractant and distribute the fish attractant while the lure is in the water.

### BACKGROUND OF THE INVENTION

Fishing has developed from a necessity to provide food to a sport or hobby. Originally fishing involved the use of live bait to catch fish using a fishing pole or line. The development of artificial lures that simulate live bait in both appearance and motion provided fishermen the ability to reuse fishing lures without the need to capture and replace live bait. Further advancement in fishing has been with the invention and use of fish attractant. Fish attractant is available in both a liquid and paste. Some applications of using liquid attractant involve injecting the attractant into a lure or dispensing the liquid attractant from a reservoir in front of the lure.

There are several patents that disclose the use of liquid attractant with fishing lures. U.S. Pat. No. 5,321,906 issued to Alexander A. Bommarito on Jun. 21, 1994, U.S. Pat. No. 4,964,235 issued to Charles Gruelle on Oct. 23, 1990, and U.S. Pat. No. 4,888,907 issued to Floyd M. Gibbs on Dec. 26, 1989 disclose the use of a liquid attractant that is placed into a cavity and is slowly released while fishing to attract fish. While these patents disclose the use of attractant with a fishing lure, they require filling the cavity with a special tool and are difficult to clean because the cavity is nearly surrounded with the lure or housing. They further are not intended for use with attractant paste nor can they simply be spread onto the lure and retained on the sides of the lure where it can be slowly released.

There are several patents that disclose the use of paste that is injected into a cavity of a lure or placed within a rechargeable container that is placed within the body of the lure. U.S. Pat. No. 5,471,780 issued to Lee E. Hopson on Dec. 5, 1995, U.S. Pat. No. 5,517,781 issued to Anthony P. Paoletta, Jr. on May 21, 1996, U.S. Pat. No. 3,108,289 issued to W. McGuire on Oct. 29, 1963 and U.S. Pat. No. 2,129,245 issued to W. J. Stenstrom on Sep. 6, 1938 disclose a lure with an internal cavity where fish attractant is placed or injected. While these patents disclose the use of attractant with a fishing lure, they require filling the cavity with a special tool and are difficult to clean because the cavity is nearly surrounded with the lure or housing. They further are not intended for use with the attractant placed within the lure and not on the sides where the attractant can be simply spread onto the lure and retained on the sides of the lure where it can be slowly released.

U.S. Pat. No. 6,079,146 issued to Walter C. Larson on Jun. 27, 2000 discloses a fish lure scent strip. The scent strip is adhered to the side or sides of the lure and the attractant is dispensed into the water as the lure is moved. While this patent provides the use of fish attractant to a fishing lure, it requires the user to cut one or more strips and apply them to the lure when the lure is dry. After the attractant is used the fisherman needs to remove the tape. This patent further does not allow the fisherman the ability to determine if the attractant is still active.

U.S. Pat. No. 4,962,609 issued to Russell D. Walker on Oct. 16, 1990 discloses a fishing lure with fibrous material existing on the sides of the lure. Attractant is placed into the fibrous material where it is distributed into the water as the lure is moved through the water. While this patent disclose the use of attractant with a fishing lure, the fibrous material is difficult to clean and it is difficult to determine how much attractant is still present in the fibrous material area.

What is needed is a fishing lure with surface details that allow a fisherman to spread attractant paste into the lure, and the amount of attractant can be seen on the lure. The surface details can be easily cleaned with items that exist at or near the water and do not require the fisherman to bring additional items to place the paste onto the lure or clean the paste out of the surface details of the lure.

Various objects, features, aspects, and advantages of the present invention will become more apparent from the following detailed description of preferred embodiments of the invention, along with the accompanying drawings in which like numerals represent like components.

### BRIEF SUMMARY OF THE INVENTION

It is an object of the present invention to provide a fishing lure or sinker for use with fish attractant. The fish attractant provides an advantage to fishermen because it provides a scent for fish to follow and brings fish to the lure.

It is another object of the present invention to provide a fishing lure or sinker with surface details or depressions where a fisherman can manually smear fish attractant bait into the surface details and the surface details retain the fish attractant when the lure is cast and pulled through the water.

It is another object of the present invention to provide a fishing lure or sinker with surface details consist of elongated grooves that are placed on the sides of the lure or sinker to simulate the appearance of a fish or other type of lure.

It is another object of the present invention to provide a lure or sinker with multiple holes placed along the sides of a fishing lure or sinker to provide a retention mechanism for a paste type attractant to be smeared into the holes by a fisherman.

It is another object of the present invention to provide a lure or sinker with hooks or hook attachment details to catch the fish.

It is another object of the present invention to provide a lure or sinker with surface details of one or various sizes and shapes where the fish attractant bait can be placed and retained.

It is another object of the present invention to provide a lure or sinker that has the appearance of fish, frogs, grasshoppers, and or other insects or water creatures that a fish might feed upon.

It is another object of the present invention to provide a lure with sound making capability in addition to the surface details where fish attractant can be placed.

It is a further object of the present invention to provide the surface details that allow for slow dispersion of the fish attractant into the water near the fishing lure or sinker to aid in catching fish.

A still further object of the present invention to provide the surface details that can be cleaned with material that exists near or at a body of water such as sticks, sand, rocks or other natural media. The lure can also be provided with additional cleaning tools such as a brush and auger to provide a more thorough cleaning and a hook sharpening file.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIGS. 1A-1F are side views of fishing lures and sinkers with elongated surface details.

FIG. 2A-2C are cross sectional views of the surface details of the embodiments from FIGS. 1A-1F.

FIG. 3A-3F are side views of fishing lures and sinkers with holes for retaining fish attractant.

FIG. 4 are detailed views of various hole profiles that can be used in the lures and sinkers shown in FIGS. 3A-3F.

FIG. 5 is an exploded isometric view of one embodiment of a cleaning tool showing the various components.

### DETAILED DESCRIPTION

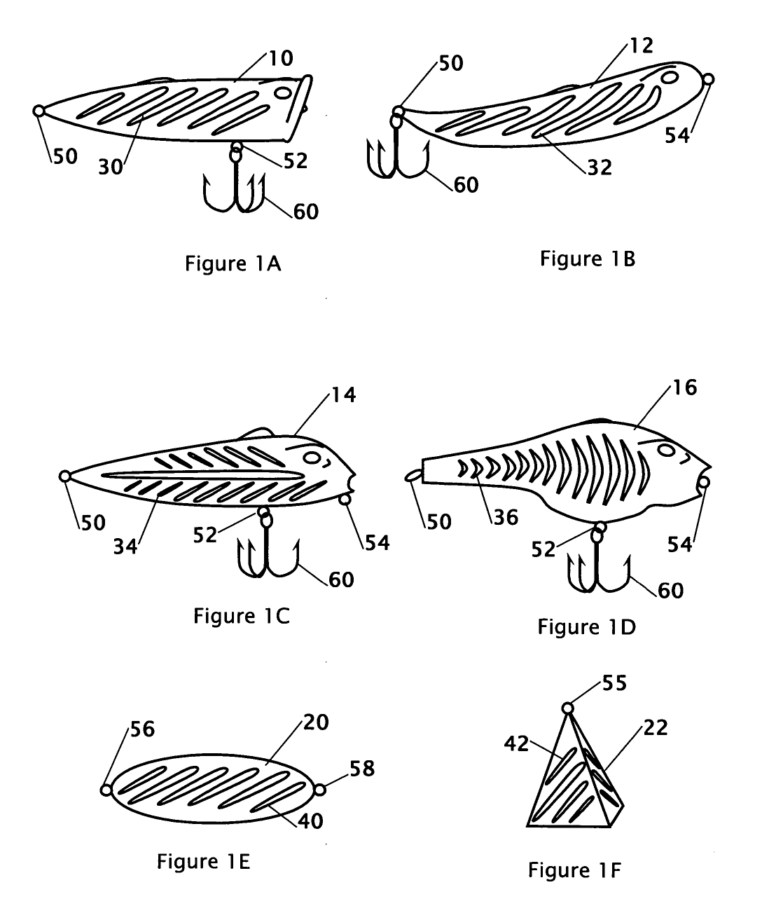

Referring to the drawings by numerals of reference, FIGS. 1A-1F show side views of fishing lures and sinkers with elongated surface details. FIGS. 1A, 1B, 1C, and 1D show various configurations of fish shaped lures 10, 12, 14 and 16 respectively. These different types of lures are shown for descriptive purposes to show the various configurations of elongated surface details where the surface features can be placed to provide retention and distribution of fish attractant that is spread into the surface details. Various other types of lures are contemplated including but not limited to the types more commonly known as poppers, chuggers, stick bait, hard baits, crank baits, spoons, plugs, darts, puppies or spinners. The lures shown reflect hard molded, formed, stamped, carved, cast or fabricated lures. The lure can be made from a flexible material that more closely resembles the motion feel and appearance of an actual water creature. While fish are shown in these figures other lures are contemplated that are shaped like a fish, frog, crawdad, grasshopper, cricket, worm or other living organism that lives near or in the water. The lures have a variety of cosmetic features such as eyes, mouth, and or colors to make the lure have the appearance of the creature they are simulating.

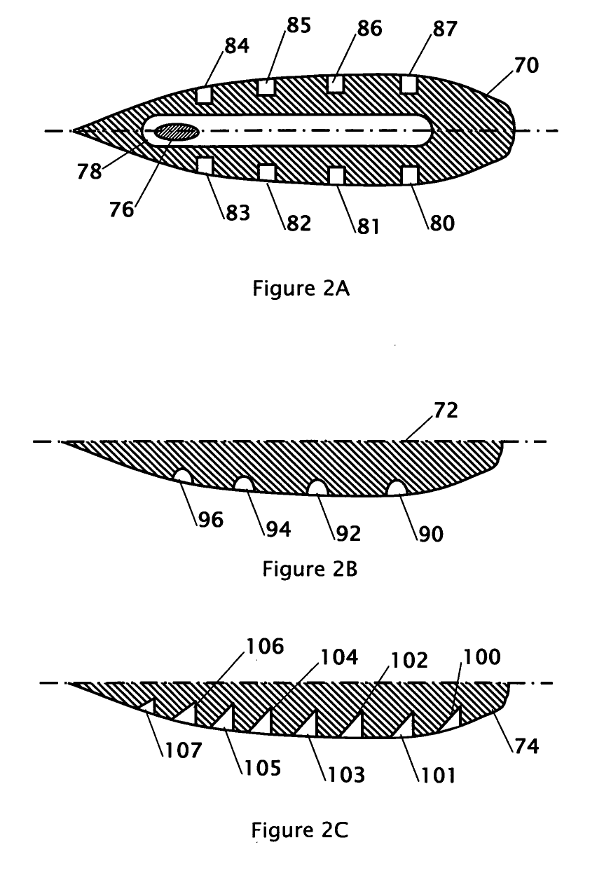

Each lure includes a hook(s) 60 and or a hook attachment feature 50, 52, 54. These hook and hook attachment features allow for hook(s) 60 to be placed onto the lure, or the lure can be connected to a fishing line with connection 54. It is also contemplated that the lure can have connections at the front 54, back 50 and middle section 52 of the lure to allow for hooks, lines and multiple lures to be connected together. The surface features in these figures consist of elongated grooves 30, 32, 34, and 36. One or more elongated grooves exist on each side of the lure. More detail of some cross-sections of the elongated surface features are shown and described in more detail in FIGS. 2A-2C. The surface features provide retention for fish attractant paste that is spread onto the sides and into the surface features of the lure. In FIG. 1A the surface features consist of straight recesses placed diagonally across the sides of the lure. In FIG. 1B the surface features consists of arched recessed placed diagonally across the sides of the lure. In FIG. 1C the surface features 34 consist of a herring bone pattern of recesses that enhance the appearance of bones on the lure. In FIG. 1D the multiple arched recessed 36 are placed along the side of the lure. While various styles of surface details are shown, the elongated surface features extend along the length vertically on an angle or combination thereof on the body of the lure. It is further contemplated that the lure can be made from metal and the surface details are machined, formed, rolled or stamped into the metal.

FIGS. 1E and 1F show two different types of sinkers 20 and 22. These types and shapes of sinkers are shown representing types of sinker where the surface features can be placed to provide retention and distribution of fish attractant that is spread into the surface details. The surface features in these figures consist of elongated grooves 20 and 22. One or more elongated grooves exist on each side of the sinker. More detail of some cross-sections of the elongated surface features are shown and described in more detail in FIGS. 2A-2C. The surface features provide retention for fish attractant paste that is spread onto the sides and into the surface features of the sinker. In FIG. 1E the surface features consist of straight recesses placed diagonally along the sides of the sinker. In FIG. 1F the surface features consists of grooves 42 placed diagonally across the sides of the sinker. While two common shapes of sinker are used the elongated recesses it is contemplated that the recessed can be placed on sinkers including but not limited to round, elliptical, pyramid, diamond or square in shape. One or more fishing line retention components 55, 56 and 58 are shown for connection with fishing lines or hooks.

FIG. 2A-2C are cross sectional views of the surface details in the embodiments from FIGS. 1A-1F. The fish attractant paste is manually spread or smeared across the side(s) of the lure where it collects inside the surface feature. In all configurations of recesses fish attractant paste is spread along the side(s) of the lure or sinker and is collected within the recessed area(s). The recesses allow the fish attractant to be retained within the recesses and prolong how long it will take for the fish attractant to be washed from the lure or sinker thus prolonging the interval required between re-applying the fish attractant. As the lure is sitting or moved through the water some of the fish attractant is slowly washed from the lure. Because the recesses are located on the outer surface of the lure and sinker the amount of fish attractant can be visually seen. Once a person is done fishing the fish attractant can be washed from the recesses with a cleaning tool, stick, rock, branch, sand or using other material that is available at or near a waterway. In all contemplated embodiments of the elongated recesses the recesses only extend a finite depth into the lure or sinker.

FIG. 2A shows a cross sectional view of a lure or sinker 70 where the recesses 80-87 are rectangular or square is cross section. This figure also shows a hollow opening 78 located within the body of the lure or sinker. Within the hollow body a noise making component 76 is placed that provides some audible sound while the lure or sinker is moved through the water.

FIG. 2B shows a cross sectional half of a lure or sinker 72 with elongated recesses that are arched, round or curved 90, 92, 94 and 96 in cross section. FIG. 2C shows a cross sectional half of a lure or sinker 74 with elongated recesses that are saw toothed or triangular 100-107 in cross section. While each figure shows only one type of cross sectional shape on a lure or sinker it is contemplated that multiple cross sectional shapes can be placed in a single lure or sinker.

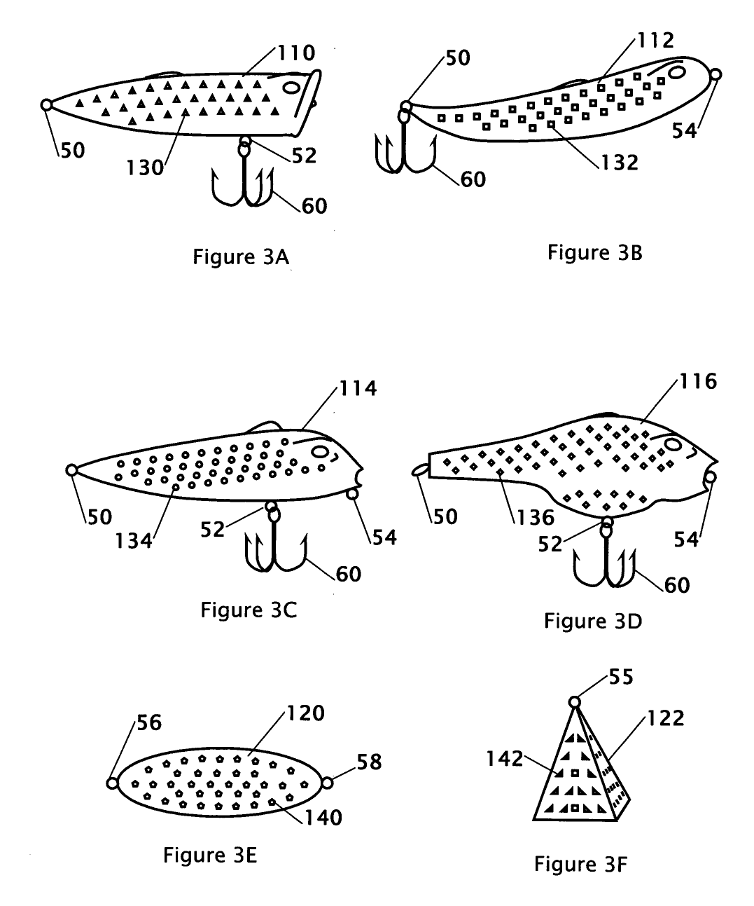

FIG. 3A-3F are side views of fishing lures and sinkers with holes for retaining fish attractant. FIGS. 3A, 3B, 3C, and 3D show various configurations of fish shaped lures 110, 112, 114 and 116. These different types of lures and sinkers are shown for descriptive purposes to show the various configurations of holes used to provide retention and distribution of fish attractant that is spread into the surface details. Various other types of lures are contemplated including but not limited to the types more commonly known as poppers, chuggers, stick bait, hard baits, crank baits, spoons, plugs, darts, puppies or spinners. The lures shown reflect hard molded, formed, stamped, carved, cast or fabricated lures. The lure can be made from a flexible material that more closely resembles the motion feel and appearance of an actual water creature. While fish are shown in these figures other lures are contemplated that are shaped like a fish, frog, crawdad, grasshopper, cricket, worm or other living organism that lives near or in the water. The lures have a variety of cosmetic features such as eyes, mouth, and or colors to make the lure have the appearance of the creature they are simulating.

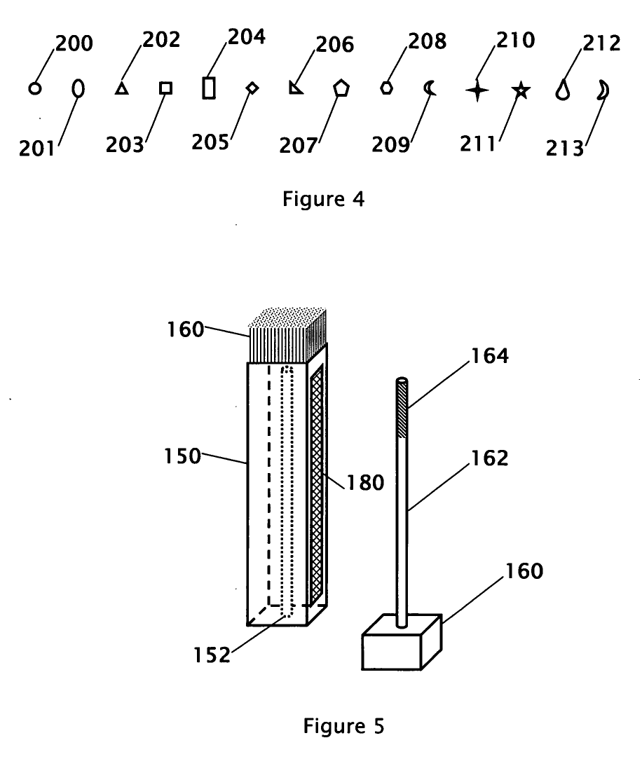

Each lure includes a hook(s) 60 and or a hook attachment feature 50, 52, 54. These hook and hook attachment features allow for hook(s) 60 to be placed onto the lure, or the lure can be connected to a fishing line with connection 54. It is also contemplated that the lure can have connections at the front 54, back 50 and middle section 52 of the lure to allow for hooks, lines and multiple lures to be connected together. The surface features in these figures consist of triangular holes 130, rectangular holes 132, round holes 134, diamond shaped holes 136 on the side(s) of the lure. A number of different shapes of holes are contemplated and some of the shapes are shown in FIG. 4. The surface features provide retention for fish attractant paste that is spread onto the sides and into the surface features of the lure. It is further contemplated that the lure can be made from metal and the surface details are machined, formed, rolled or stamped into the metal. The minimum contemplated diameter of the holes is 0.01 inches in diameter, but a preferred diameter is 0.031 to 0.062 inches in diameter.

FIGS. 3E and 3F show two different types of sinkers 120 and 122. These types and shapes of sinkers are shown represent types of sinker where the surface features can be placed to provide retention and distribution of fish attractant that is spread into the surface details. The surface features in these figures consist of pentagonal holes 140 on the sinker shown in FIG. 3E and a combination of triangular 142 and square holes shown in FIG. 3F. The holes can exist on one side, around the lure or on multiple sides of the lure. While two common shapes of sinker are shown it is contemplated that the holes can be placed on sinker including but not limited to round, elliptical, pyramid, diamond or square in shape. One or more fishing line retention components 55, 56 and 58 are shown for connection with fishing lines or hooks.

FIG. 4 are detailed views of various hole profiles that can be used in the lures and sinkers shown in FIGS. 3A-3F. These hole shapes disclose some of the possible shapes, but many others beyond the shapes disclosed are contemplated. The shapes include but are not limited to round 200, elliptical 201, triangular 202, square 203, rectangular 204, diamond 205, angled 206, pentagonal 206, hexagonal 208, moon 209, four sided star 210, five or more sided star 211, tear drop 212 and banana 213.

FIG. 5 is an exploded isometric view of a cleaning tool showing the various components. This tool is one contemplated cleaning tool that can be included with and used with the fishing lure or sinker. The cleaning tool is shown in exploded condition where the cleaning auger 160 is shown outside of the base 150. The auger includes a cap portion 160 that a person holds and uses the auger tip 164 located at the end of shaft 162 to clean holes or recesses that may become filled with fish attractant. When finished the auger shaft 162 is placed into the hole 152 in the base 150. The base includes a brush type top 170 that is used to clean the elongated surface recesses of lures and sinkers. It is further contemplated that a hook sharpening file is located on side 180 to allow for sharpening of a hook.

Thus specific embodiments and applications for a fishing lure and sinkers been disclosed. It should be apparent, however, to those skilled in the art that many more modifications besides those described are possible without departing from the inventive concepts herein. The inventive subject matter, therefore, is not to be restricted except in the spirit of the appended claims.

1. A fishing lure for holding and distributing fish attractant comprising:
a rigid or pliable fishing lure body having sides that include a plurality of elongated surface features existing intermittently on opposing sides of the body wherein;
the surface features have a width of 0.01 to 1.0 inches and a depth that is less that 25% of the width of the lure body;
the intermittent surface features allow for at least temporal retention of fish attractant paste that can be manually applied into the elongated surface features of the lure and when the lure is placed in water or moved through water the fish attractant is distributed from the surface features to the water.

2. The fishing lure according to claim 1 wherein the elongated surface features extend lengthwise, vertically, at an angle or combination thereof on the body of the lure.

3. The fishing lure according to claim 1 that further includes at least one noise or sound making mechanism.

4. The fishing lure according to claim 1 wherein the lure is selected from a group consisting of poppers, chuggers, stick bait, hard baits, crank baits, spoons, plugs, darts, puppies or spinners.

5. The fishing lure according to claim 1 wherein the lure is shaped from group consisting of fish, frogs, crawdads, grasshoppers, crickets, worms and other living organism that lives near, on, or in the water.

6. (canceled)

7. The fishing lure according to claim 1 wherein that further includes a hook or attachment feature for a hook.

8. The fishing lure according to claim 1 wherein the elongated surface feature has a cross sectional area of a rectangle, triangle or ellipse.

9. The fishing lure according to claim 1 that further includes a cleaning tool comprising a combination of a hole clean out tool, a brush, an augur and a hook sharpener.

10-20. (canceled)

21. The fishing lure according to claim 1 wherein the intermittent surface features are symmetric on both sides of the lure.

22. A fishing lure for holding and distributing fish attractant comprising:
a rigid or pliable fishing lure body having sides that include a plurality of geometric holes on the sides of the lure body wherein;
the geometric holes have a depth of less than 25% of the width of the lure body;
the plurality of geometric holes allow for at least temporal retention of fish attractant paste that can be manually applied into the geometric holes in the lure and when the lure is placed in water or moved through water the fish attractant is distributed from the geometric holes to the water.

23. The fishing lure according to claim 22 wherein the geometric holes extend in a staggered pattern along the body of the body of the lure.

24. The fishing lure according to claim 22 that further includes at least one noise or sound making mechanism.

25. The fishing lure according to claim 22 wherein the lure is selected from a group consisting of poppers, chuggers, stick bait, hard baits, crank baits, spoons, plugs, darts, puppies or spinners.

26. The fishing lure according to claim 22 wherein the lure is shaped from a group consisting of fish, frogs, crawdads, grasshoppers, crickets, worms and other living organism that lives near, on, or in the water.

27. The fishing lure according to claim 22 wherein that further includes a hook or attachment feature for a hook.

28. The fishing lure according to claim 22 wherein the geometric holes are shaped from a group consisting of round, ellipse, triangle, square, rectangle, diamond, pentagonal, hexagonal, moon, four sided star, five sided star, tear drop and banana.

29. The fishing lure according to claim 22 wherein the geometric holes are symmetric on both sides of the lure.

30. The fishing lure according to claim 22 that further includes a cleaning tool comprising a combination of a hole clean out tool, a brush, an augur and a hook sharpener.
